(19) United States
(12) Patent Application Publication
(10) Pub. No.: US 2006/0215733 A1
(43) Pub. Date: Sep. 28, 2006

(54) TIMING-SPECTRUM SPACE CODING FOR CDMA COMMUNICATIONS

(75) Inventor: NGAN-CHEUNG PUN, FAIRPORT, NY (US)

Correspondence Address: NGAN-CHEUNG PUN, 98 HAMMOCKS DRIVE, FAIRPORT, NY, 14450, US

(73) Assignee: NGAN-CHEUNG PUN, FAIRPORT, NY (US)

(21) Appl. No.: 11/307,157

(22) Filed: Jan. 26, 2006

Related U.S. Application Data
(60) Provisional application No. 60/649,215, filed on Feb. 2, 2005.

(51) Int. Cl. H04B 1/00

(52) U.S. Cl. 375/142

(57) ABSTRACT

This invention is about using the timing or phase relationship of a special type of wavelet to encode information bits. The special type of wavelets is constructed from a CDMA code, such as a PN code sequence, that has sufficiently good auto correlation and cross correlation properties. The wavelet, having such properties, would tend to have a large space of detectable or distinguishable phases. The wavelet can be either, phase rotated or timing shifted to encode information bits. For example, a wavelet constructed from a PN code of 16 chips may be able to encode 10 information bits, if the noise level permits. The newly utilized vector space (the time domain or phase domain of this type of wavelets) for information bits encoding has substantially increased the spectral efficiency in communication systems.

### CROSS-REFERENCE TO RELATED APPLICATIONS

The present Application for Patent claims priority to Provisional Application Ser. No. 60/649,215, entitled “Timing-Spectrum Space Coding For CDMA Communications”, filed Feb. 2, 2005.

### FEDERALLY SPOSORED RESEARCH

Not Applicable

### SEQUENCE LISTING OR PROGRAM

Not Applicable

### FIELD OF THE INVENTION

The present invention relates to systems and methods for increasing the bandwidth efficiency in the Code Division Multiple Access (CDMA) communication systems.

### BACKGROUND OF THE INVENTION

CDMA is one kind of spread-spectrum technology. The information bits, often represented by a narrow band symbol, are modulated with a pseudo-random spreading code. This code is a binary sequence, represented by a number of chips. The binary code sequence is often referred as a pseudo-noise (PN) code. The number of chips in the code is also called the code length. As the result of such modulation, the narrow band data signal is spreading out into a much wider band of frequency. In the same frequency band, there can exist many different independent channels using different spreading codes. In such a frequency band, multiple users can communicate simultaneously without damaging interference from each other and thereby resulting a Code Division Multiple Access communication scheme.

The Pseudo-Noise codes used in CDMA must have certain particular properties. First, the cross-correlation between any two codes must be small. It is good for separating the channels. If the cross-correlation is zero, then the two codes are orthogonal. An example is the Walsh-Hadamard code. The inter-channel interference can be brought down to minimum. In a non-coherent detection system, the PN codes must have good auto-correlation properties. It means that the code correlates with itself would result with a single distinctive peak. In a multi-path channel conditions, multiple peaks may be detected, each due to a different delayed path. The signal related to each peak can be combined using a Rake Receiver to construct a stronger signal.

Traditional CDMA coding techniques are combined with some modulation schemes such as Binary Phase Shift Keying (BPSK), Quadrature Phase Shift Keying (QPSK), and so on to increase the bandwidth utilization. However, the way of which modulation is applied is distinctively different from the current invention method. For example, in a QPSK modulation for the CDMA system, information bits are separated into two binary streams, named 1 bits, and Q bits. Each data bit is then modulated by a CDMA PN code to spread into a long sequence of binary chips. In this way, each data bit is now represented by a longer sequence of binary chips. The PN code employed for I, and Q data bits could be the same, or different. Then for each chip period, two chips, one from the I stream, and another from the Q stream, will be modulated together with the carrier signal into a QPSK symbol.

Wavelet is constructed and used in the current invention. In general, a wavelet is a small wave with limited time span. It is commonly used to compress digital images. The simplest form of wavelet is a simple sinusoidal wave. It is a basic component for transforming a signal from the time domain into the frequency domain, known as Fourier Transform.

### SUMMARY OF THE INVENTION

This invention is about using the timing or phase relationship of a special type of wavelet to encode information bits. The special type of wavelets is constructed from a DS-CDMA code, such as a PN code sequence, that has sufficiently good auto correlation and cross correlation properties. The wavelet, having such properties, would tend to have a large space of detectable or distinguishable phases. The wavelet can be either, rotated or shifted in the time domain to encode information bits, producing a wavelet symbol. Phase rotation is defined, as a shift and a wrap-around; thereby the energy of the wavelet packet is not time shifted. However, a timing shift of the wavelet causes the energy of the wavelet packet to be actually shifted in time.

Like CDMA codes, multiple distinct wavelets can be superposed as different channels and they can carry independent information bits. At the receiver, the multiplexed channels can be separated again by using the cross correlation properties.

A wavelet with good auto-correlation properties, the correlation output is a single spike in the time domain. And auto correlation of multiple distinct wavelets would produce multiple and distinguishable spikes in the time domain. It looks like a timing spectrum (as shown in FIG. 8). This apparent characteristic of the correlation output gives the title of the present invention that is called Timing Spectrum Space Coding (TSSC).

In this method, information bits are encoded in (a) the timing shift dimension, or (b) the phase dimension provided by the wavelet.

In the timing shift case, the space of the dimension is limited by two factors: the wavelength of the wavelet Ts, and the resolvable timing resolution (Tr) of the wavelet. The encoded wavelet is time shifted, called a wavelet symbol. This called timing shift modulation.

In the phase rotation case, the space of the dimension is limited by two factors: the full phase (2*π) of the wavelet and the resolvable phase resolution (Pr) of the wavelet. The encoded wavelet is phase rotated, called a wavelet symbol. This is called phase rotation modulation.

The amount of information bits, R can be encoded in the wavelet symbol is equal to log2(M), where M is the ratio of the wavelength (Ts) to the resolvable timing resolution (Tr), M=Ts/Tr. Equivalently in the phase dimension, the wavelet length is translated into 2*π and the resolvable timing resolution is translated into the resolvable phase angle that is given by Pr=2*π/M.

The wavelet constructed from the CDMA code sequence can still be used to carry the information bits in the traditional manner. Independently, additional information bits would be encoded in the TSSC scheme. Therefore, the TSSC scheme increases the spectral bandwidth efficiency significantly.

### BRIEF DESCRIPTION OF DRAWING

FIG. 1 shows a process of how a wavelet is constructed from a CDMA based binary code sequence.

FIG. 2 show the concept of how a wavelet is divided into M smaller intervals, providing the discrete levels, for information bits encoding.

FIG. 3 shows the concept of how a wavelet symbol is constructed in the phase domain.

FIG. 4 shows the concept of a slot construction by using phase rotated wavelet symbols.

FIG. 5 shows the concept of slot construction by using timing shifted wavelet symbols.

FIG. 6 shows the concept of demodulation by using the auto correlation and cross correlation properties of the wavelets.

FIG. 7 shows an example of a TSSC modulation using multi-coded system.

FIG. 8 shows an example of the TSSC demodulation of a multi-coded system.

### DETAILED DESCRIPTION

The construction of a special type of wavelets, that has good auto correlation and cross correlation properties, gives a new dimension to encode information bits. The new dimension is created by using the highly detectable characteristics in the phase and time domain. This type of wavelets can be faithfully constructed from a CDMA based class of binary code sequence that exhibits the same properties. The major difference of the wavelet from the binary code sequence is that the wavelet is represented by a much higher number of discrete sampling points. Therefore the wavelet can be shifted or rotated at a very fine scale. Every possible steps of rotation or timing shift can be used to represent a piece of information. Therefore if there are M possible steps of phase rotation or timing shift then there are log2(M) bits of information can be encoded. How small a step can be set such that it is still detectable at the receiver depends on the noise level or other types of interference presented in the channel.

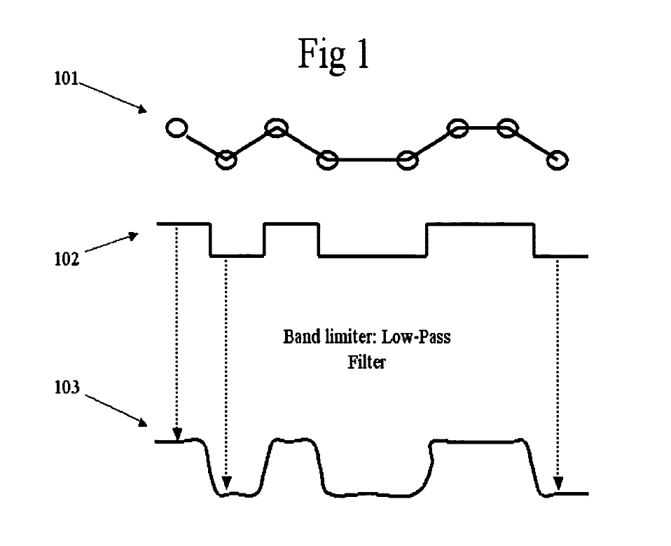

FIG. 1 shows a process of how a wavelet is constructed from a binary code sequence. To illustrate the concept, the example uses a simple binary code 101. It has 8 binary chips. The wavelet 103 is being constructed from the binary code sequence 101. The expanded wavelet would have a large number of discrete sample points, such as 1280 points. Wavelet 102 is an intermediate wavelet, which is directly expanded from the binary code sequence, proportional in shape. The intermediate wavelet 102, passes through a low pass filter to form the final desired band-limited wavelet 103.

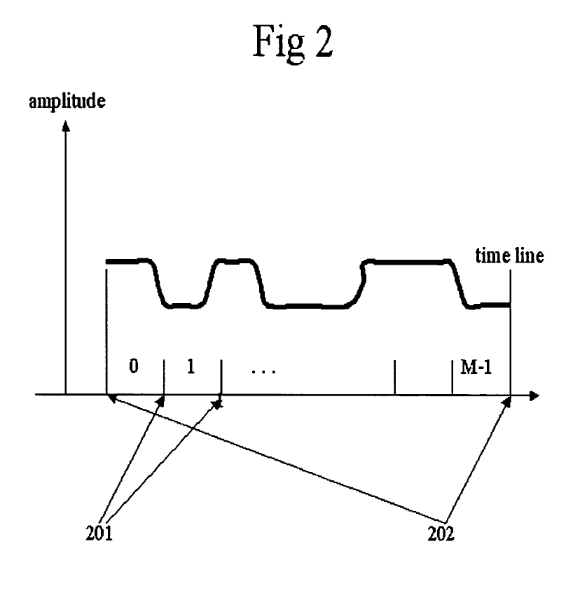

FIG. 2 shows the concept of how a wavelet is divided into M small intervals. For example, M=128 (intervals). The wave period 202 is the wavelength of the wavelet, denoted by Ts (for example, represented by 1280 discrete samples). Each small interval 201 has a period of 1/M of the wavelength. For a given channel condition such as noise, M can be maximized so that any timing change (or phase change) of step 1/M can still be detected at the receiver. The confidence of the detection at the receiver is designed to satisfy a predefined BER requirement. For such a value of M, log2(M), denoted by R, is the number of bits that a wavelet symbol encodes. And the time period of the small interval 201 is called the resolvable timing resolution, denoted by Tr. In the phase domain, the equivalent resolvable phase angle is defined by Pr=(2*π)/M.

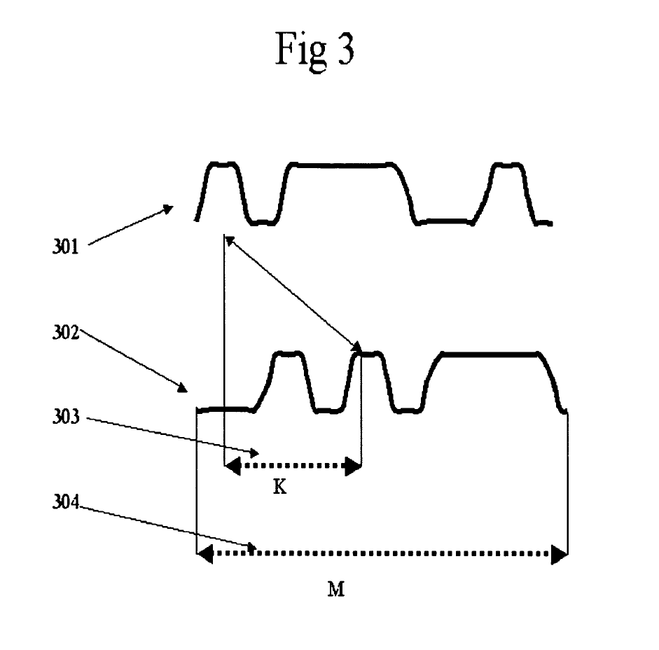

FIG. 3 shows the concept of how a wavelet symbol is constructed in the phase domain. The wavelet symbol 302 is constructed by rotating the wavelet 301. The wavelet has M possible discrete levels 304 for rotations; thereby having M possible instance of the wavelet symbols. A wavelet symbol K 303 is obtained by rotating the wavelet by K steps. Each step is equal to Tr in the time domain. Any instance of wavelet symbol K can be mapped to a set of information bits. The number of bits is equal to R=log2(M). K has possible values range from 0 to (M−1).

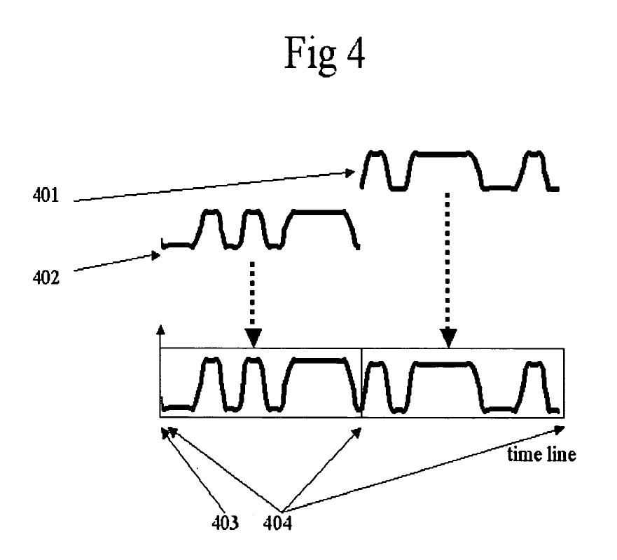

FIG. 4 shows the concept of a slot construction by putting the wavelet symbols of phase rotated, for example 401 and 402, into the symbol intervals of the slot. The symbol periods are defined as fixed intervals from the beginning of the slot 403. The symbol period boundaries 404 are defined as where the symbol should begin and end. Some wavelet symbol of predetermined instance (usually K=0) would be used for slot synchronization. As the beginning of the slot can be determined at the receiver, the subsequent symbol period boundaries can be determined. Due to the different degrees of time-variant nature of the signal in different communication systems, not all the slots are required to include predetermined wavelet symbols for timing synchronization.

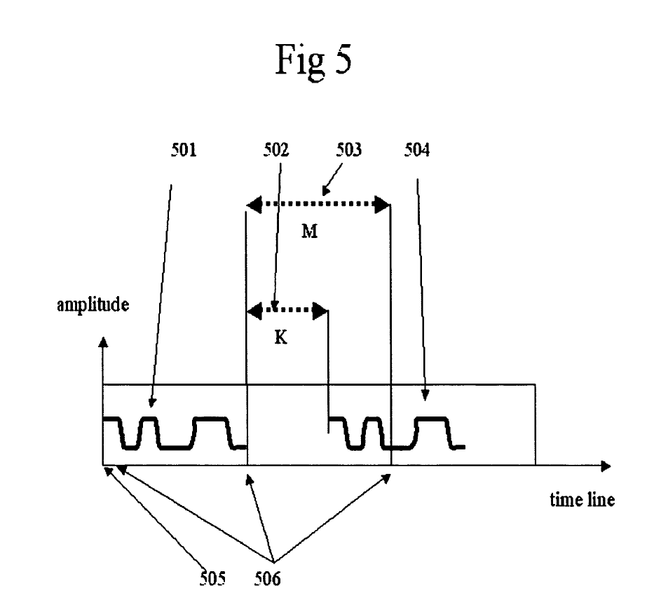

FIG. 5 shows the concept of slot construction by putting the wavelet symbols of timing shifted, for example 501 and 504, into the symbol intervals of the slot. The beginning of the slot 505 is predefined by a synchronization wavelet 501. The symbol periods are defined as fixed intervals 506 from the beginning 505 of the slot. Each discrete interval is equal to the natural wavelength of the wavelet. Unlike the phase shifted wavelet symbol, the energy of a wavelet packet, such as 504, is actually time delayed. The wavelet symbol 504 is time delayed by (K*Tr); thereby the energy of the symbol could be overlapping with the next wavelet symbol. There are M 503 possible discrete values of timing shift. For any wavelet symbol, the maximum delay is ((M−1)*Tr). The symbol instance K 502 is mapped to a set of information bits. The number of bits is equal to log2(M).

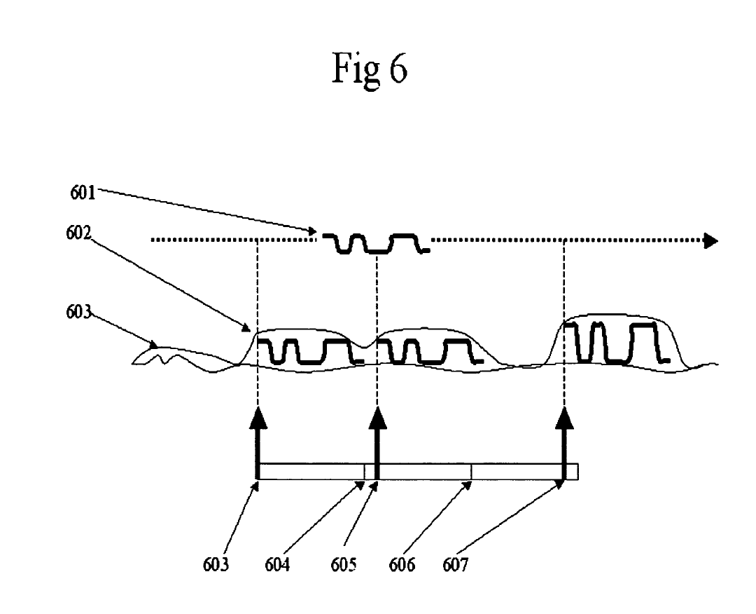

FIG. 6 shows the concept of demodulation in TSSC. For example, a received signal 603 is received at the receiver side of the communication system. The symbols are timing-shift encoded. And the wavelet, 601, used for modulation, is known to the receiver side. Therefore, the same wavelet 601 is used to auto-correlating the received signal. A series of auto correlation peaks such as 603, 605 and 607 could be obtained. The first wavelet symbol 602 is predetermined to be a slot synchronization symbol. It 602 is not timing shifted. The corresponding auto-correlation peak 603 obtained is treated as the beginning of the slot. The subsequent symbol period boundaries such as 604 and 606 can be calculated as a fixed timing offset from 603. The timing of other auto-correlation peaks will be used to compute the individual symbol instance K. For example, the symbol instance K decoded is equal to “timing of peak 604” minus “timing of the symbol boundary 605”. In the third symbol period, the wavelet instance K is equal to “timing of the peak 607” minus “the timing of the symbol boundary 606”.

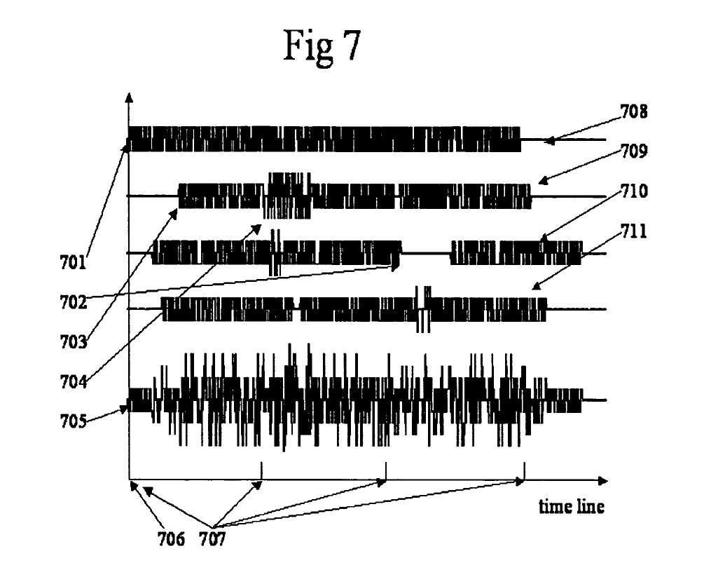

FIG. 7 shows an example of a TSSC modulation using multi-coded scheme; here there are 4 distinct binary code sequences. Each binary code sequence has been expanded into corresponding wavelets. The distinct wavelets are represented by different colors in the diagram. A color of wavelet here means a wavelet that is constructed from a unique, distinctive and orthogonal binary code sequence. Each color of wavelet can be considered as an independent user channel. The 4 colors of channel are depicted in the diagram shown as shown as 708, 709, 710, and 711. The modulation schemes such as timing shift and phase rotation can be applied distinctively and separately to each color of wavelets. However, they are all superposed together (as complex wavelet symbols) during the transmission. Signal at the bottom of the diagram 705 shows the superposed complex wavelet symbols. The first color channel 708 uses phase rotation to encode information bits. But the first wavelet symbol 701 in the slot is not phase shifted. It has a predetermined known phase, so that the receiver can use this known symbol to acquire slot synchronization. Having the capability identifying the beginning of the slot, other symbols, either rotated or timing shifted can be measured. The other 3 channels (colors) use timing shift to encode information bits. For example, the color channel 709 has the first wavelet symbol timing shifted relative to the beginning of the slot, indicated by 701. Timing shift at different timing delay in each period could result a local redistribution of wavelet packet energy in the signal, indicated by 702 and 704. As the whole complex symbol is subjected to the same channel conditions such as delayed paths, the relative timing relationships amount different wavelets in the complex symbol remains mostly unchanged.

In FIG. 7, the beginning of the slot 706 is marked by the first wavelet symbol at 701; it is a timing reference for all 4 color-channels. The symbol boundaries 707 can be calculated by using fixed timing offsets from the beginning of the slot, indicated by 706.

As all colored channels are superposed together, the resulting signal 705 is a composition of series of complex wavelet symbols. The energies of the symbols overlapping into the immediate neighbor symbols.

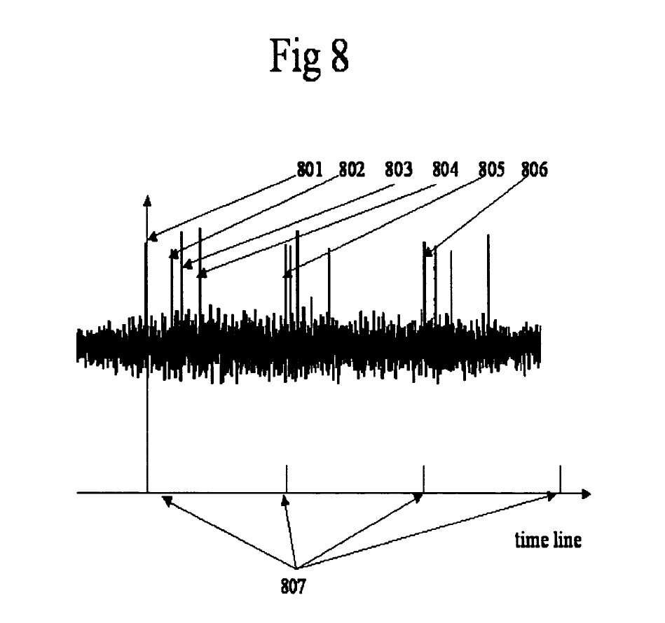

FIG. 8 shows an example of the demodulation of a multi-coded system, referred to FIG. 7. The peaks are the auto-correlation output for the 4 colored channels. The diagram has 3 symbol periods. The auto-correlation peak 801 marks the beginning of the slot. The subsequent corresponding symbol periods can be calculated as some fixed timing offsets from the beginning of the slot 801. And 807 indicates the symbol boundaries. The timing of the peaks 802 803 and 804 relative to the symbol boundary is measured in terms K*Tr. Where K is symbol instance variable, representing the decoded symbol instance, per symbol period. And K is mapped to the information bits the same way as it was encoded, per symbol period.

In FIG. 8, wavelet symbol encoded in phase rotation does not show up as timing shifted correlation peaks, in the auto-correlation time line. To determine the phase of the received symbol, the correlating wavelet itself is phase shifted to all possible instance and then auto-correlated with the received signal in the symbol period. The matching instance, such as K, that results a maximum auto correlation is considered as the decoded wavelet instance. The K is mapped to the information bits the same way it was encoded.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for modulating information bits for a communication system comprising: (a) a set of distinct predetermined binary code sequences to be available, (b) said predetermined binary code sequence having sufficient auto correlation capabilities, and cross correlation capabilities, (c) a set of wavelets constructed from the set of said distinct predetermined binary code sequences.

2. The closure of claim 1 wherein further comprising a wavelet transformation means which a wavelet is constructed from said binary code sequence; thereby producing a substantially higher sampling rate wave representation of the binary code sequence, for which the shape and properties, the auto correlation and cross correlation properties of said wavelet is faithfully inherited from the binary code sequence.

3. The closure of claim 2 wherein further comprising a wavelet symbol construction means for timing shifting or phase rotating the wavelet for a K number of discrete steps; the time period of said step is named a resolvable timing resolution of said wavelet; where said resolvable timing resolution, denoted by Tr, is a 1/M of the wavelength of the wavelet, denoted by Ts, in the time domain, or equivalently Pr=2*π/M in the phase domain; where said K is a selected value between and 0 and (M−1), inclusively; thereby producing a plurality of M possible instances of wavelet symbols; said wavelet symbol construction in the time domain by timing shifting of said wavelet is named a wavelet timing shift modulation; said wavelet symbol construction in the phase domain by rotating of said wavelet is named a wavelet phase modulation.

4. The closure of claim 1 wherein said predetermined binary code sequence is made of a pseudo-noise (PN) code sequence which is commonly used for Code Division Multiple Access (CDMA) applications.

5. The closure of claim 2 wherein said sampling rate of said wavelet is sufficiently high so that said resolvable timing resolution of wavelet can be represented by at least one discrete sampling points.

6. The closure of claim 3 wherein said wavelet is bandwidth limited. A low-pass filter filters a directly expanded wavelet from said binary code sequence, so that the bandwidth of the resulting said wavelet is approximately the same as the source said binary code sequence.

7. The closure of claim 4 wherein further comprising a modulation means for encoding said wavelet symbol with said information bits, comprising: (a) a mapping means for associating a R number of said information bits to one instance of said wavelet symbols; such that said R is less than or equal to log2 of said M; thereby all the possible values of said R information bits can be uniquely mapped to the available instances of said wavelet symbols; thereby said wavelet symbol contains a information capacity of said R information bits, (b) a slot construction means which said wavelet symbols are transmitted in a defined timing order, according to a predefined slot format, at the transmitter side of the communication system; the defined timing order is a shared knowledge for both the transmitter side and the receiver sides; thereby providing a necessary information for the receiver side of the communication system to decode said wavelet symbols.

8. The closure of claim 7 wherein further including a multi-coded channel modulation means for putting a plurality of said wavelet symbols, each originating from said distinct binary code sequences, to add as a vector sum to form a complex wavelet symbol; the addition of said vector sum is based on a common time frame with reference to said time slot; thereby the timing of a component wavelet symbol of said complex symbol can be estimated at the receiver side of said communication system; at least one of said wavelet symbols in said time slot format, is designated for synchronization by using a plain instance of said wavelet symbols.

9. The closure of claim 7 wherein further including a demodulation means for retrieving said information bits from a received signal, at the receiver side of the same said communication system, comprising: (a) a synchronization means for extracting the initial timing reference of said time slot, by correlating said received signal with said designated predetermined instance of wavelet symbol, by sliding said plain instance of wavelet symbol over the time line; the time line is formatted as a time slot, composing of symbol periods; (b) a timing shift demodulation means for detecting wavelet symbols and identifying which coded instance of the wavelet symbols is being presented in said received signal, at said symbol period of the time slot, by correlating the received signal with the same, known wavelet used for encoding; the correlation output produces distinctive spike on the time line; the timing delay of said spike is measured from the start of the symbol period boundary; the timing shift is said equal to K*Tr; K is then associated with information bits the same way as it was encoded; (c) a phase rotation demodulation for detecting wavelet symbols which has been encoded in said phase rotation modulation at the transmitter; the same wavelet is phase rotated to all possible instance of wavelet symbols, and each of which is then correlated with the received symbol in the symbol period respectively; the one that produces the maximum correlation is recorded; without lost of generosity, take wavelet instance K be the one; phase rotated is equal to K*Pr; said information bits is mapped to K the same way as it was encoded.

10. The closure of claim 9 wherein further including a multi-coded demodulation means for retrieving said information bits form a received signal, at the receiver side of the same said communication system, comprising: repeating steps 9 (a), 9 (b) and 9 (c) for each of said component wavelet symbols of said complex wavelet symbol.
